(19) United States
(12) Patent Application Publication
(10) Pub. No.: US 2008/0091529 A1
(43) Pub. Date: Apr. 17, 2008

(54) Fly Buy Coupon System

(76) Inventors: Kenneth S. Bailey, Newport Beach, CA (US); Christopher Carmichael, Laguna Niguel, CA (US)

Correspondence Address: FISH & RICHARDSON, PC, P.O. BOX 1022, MINNEAPOLIS, MN, 55440-1022, US

(21) Appl. No.: 11/782,448

(22) Filed: Jul. 24, 2007

Related U.S. Application Data
(60) Provisional application No. 60/832,842, filed on Jul. 24, 2006.

(51) Int. Cl. G06Q 30/00

(52) U.S. Cl. 705/14

(57) ABSTRACT

Media is received over a channel and played on a media-displaying screen. An advertising system produces Windows that represent the advertising, which preferably take up 5% of the area of the screen or less. These Windows are displayed over the media, but in locations that continuously move. The Windows are displayed only for a limited time, and the user can click on them during the time they are displayed. After clicking on them, a coupon code is displayed which enables a discount on a product.

### CROSS-REFERENCE TO RELATED APPLICATIONS

This application claims priority to U.S. Provisional Application 60/832,842, filed Jul. 24, 2006.

### BACKGROUND

Some internet-based advertising abandons conventional advertising in favor of new forms; for example word-of-mouth, chatroom, or other kinds of non print media-based advertising. These kinds of advertising are less likely to be based on standard television or print media.

Alternative messaging and advertisement techniques may appeal to different segments of the population.

### SUMMARY

The present application discloses messages that are provided only at certain times, over other viewable content from an alternative channel.

An embodiment describes advertising on an internet website using special kinds of ads. The so-called fly buy ads may be portions that occupy a small area of a screen, and continually move across the screen, but are shown only at certain times, e.g. periodically or randomly. The advertisements may offer discount coupons for products.

### BRIEF DESCRIPTION OF THE DRAWINGS

FIG. 1 shows a screen of a media playing part with a moving message/coupon;

FIG. 2 illustrates providing a coupon by clicking on the moving ad;

FIG. 3 illustrates an information sheet that the user may be required to fill out in order to use the coupon;

FIG. 4 illustrates a media player; and

FIG. 5 illustrates a flowchart of a media player which may include a processor therein that carries out the steps of the flowchart.

### DETAILED DESCRIPTION

An embodiment forms a special window that is displayed over a viewable portion of a media program on a screen.

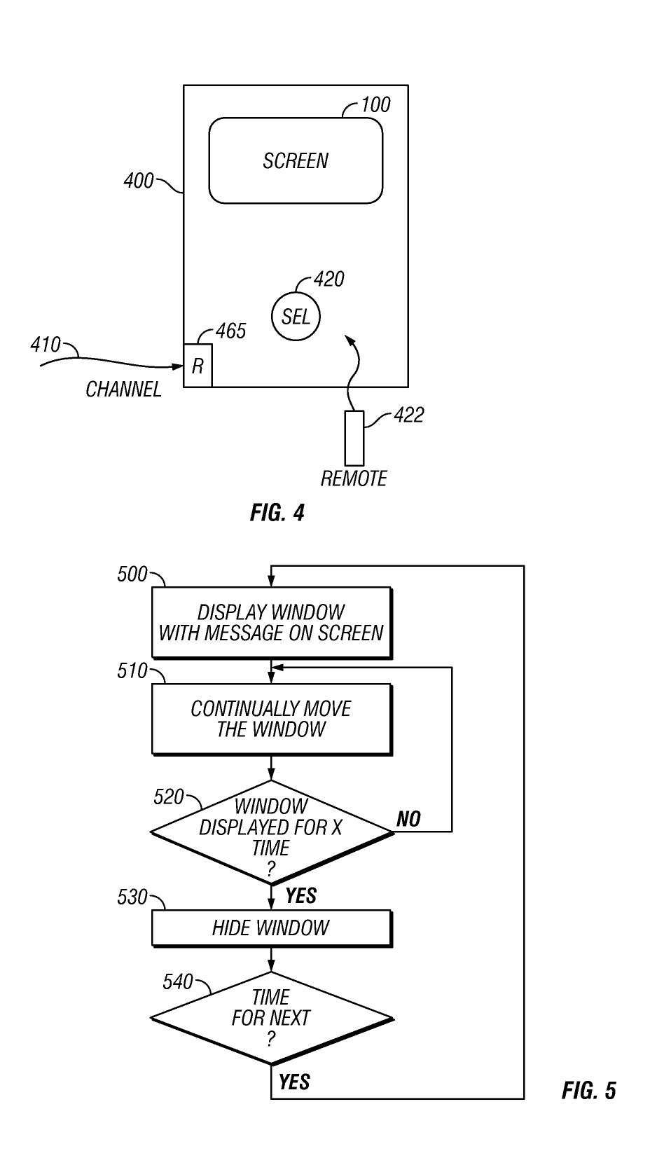

FIG. 4 illustrates a media player 400, which can be any type of device that plays any kind of viewable media on a screen 100. For example, the media player can be an MP3 player, a computer, a cellular telephone, a television, or any other device that can play any kind of multimedia clips. The media player preferably has a receiver 405 which receives information over a channel 410. The channel may be the internet, or may be broadcast waves for television, or may be wireless Ethernet or Bluetooth™.

A special message is displayed on the screen 100 according to the teachings of an embodiment. The media player 400 may include a processor therein that carries out the steps of the flowchart shown in FIG. 5. Alternately, however, the functions of FIG. 5 can simply be performed by other circuitry within any other device.

The message is displayed over the content being displayed on the screen 400. The content may be that content received over the channel 410, and therefore it may be internet content, or a video program or the like. The message may be any kind of message, although the embodiment described herein describes an advertisement that shows a selectable section that can be selected to obtain a coupon.

At 500, the message is defined as a window, e.g. can be a text box, a logo, or image, or other similar type information-conveying part, that forms a layer that can be displayed over the media content displayed on the screen. This layer can be a conventional image layer, or any other kind of box, e.g., text box, that can be displayed on a computer screen, television screen, cellular telephone or PDA screen.

The message preferably moves at all times. 510 shows the special window, which has message information therein, never staying still on the screen, but rather is always moving. Different embodiments may move this message in different ways, for example from left to right, right to left, top to bottom, and/or diagonally. The moving provides a number of different advantages. It makes the message easier to see, since moving messages can be more easily perceived by a viewer. This means that the window can be smaller, but the message can still be easily perceived. Also, since the message moves, it interferes less with the user's ability to view the underlying content on the screen. For example, if the window is blocking some part of the screen content at one moment, it will move an instant later so that the screen content can be perceived at that later instant.

Moreover, the special window is not displayed all the time, it may be displayed periodically, e.g. minutes, hours, days weeks or months, or totally at random. The flowchart of FIG. 5 shows how this is carried out. 520 determines whether the window has been displayed for the proper amount of time, here x time. X time can be 1 minute, 5 minutes, 10 minutes, or any other number. If the window has not been displayed for x time, flow returns to 510 where the window is continually moved. However, after the window has been displayed for x time, the window is hidden or terminated at 530. 540 determines if it is time for the next window to be displayed. This next time can be random, or can be periodic, or based on a trigger received over the channel 410. For example, the advertiser may determine that they want to send advertisements, and send a trigger to send the advertisement at a desired time. As explained herein, the advertisement provide coupons with expiration dates.

This enables the advertiser to wait for a slow sales day, for example, and send triggers that have limited time coupons. Since the coupons must be used within short times, this can be used as a tool to increase their sales on that slow day.

At the time for the next window, flow returns to 500, where a new window display again begins.

The special window moves across the screen requiring the user to click or otherwise actuate the window during the time it is moving, and before it disappears from sight. The window includes information about a special offer that offer can be seen only during the time that the window is being seen. For example, a retailer such as Active Ride Shop™ might advertise a logo for VCA clothing with a $25 coupon.

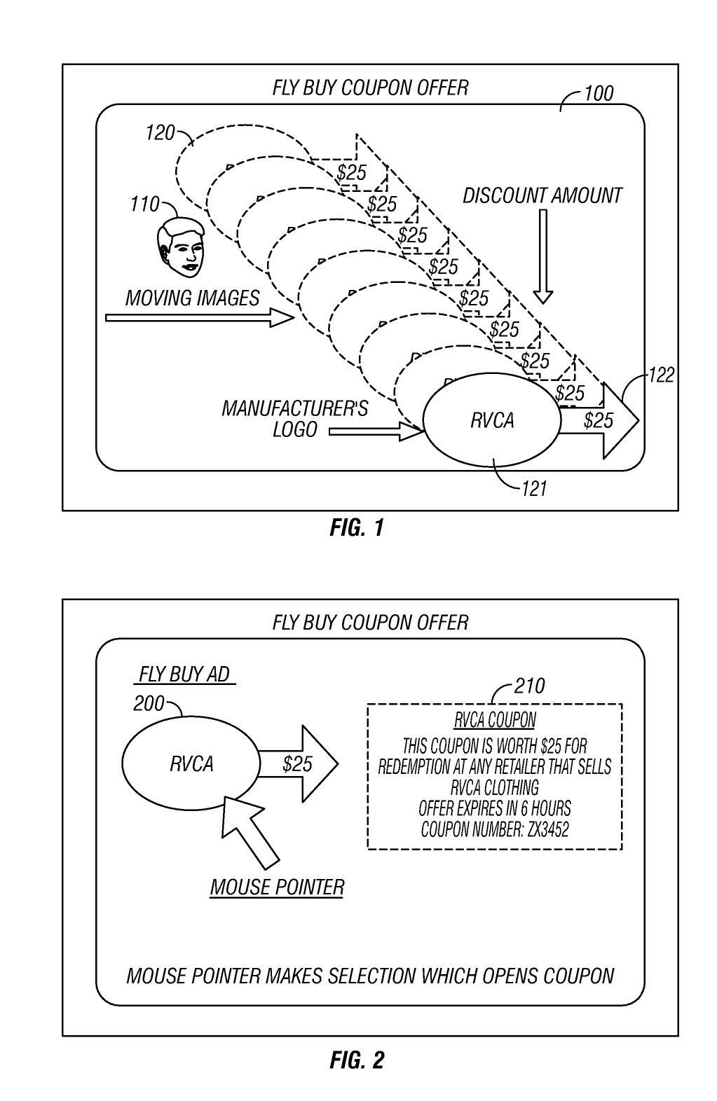

FIG. 1 illustrates the screen which is shown to the user. The screen 100 may be a screen of any visible type that is displayed to a user. Specified content 110 is being displayed on the screen 100 normally. The specified content may be a website, may be the image on the cellular telephone display, or may be the video on a television screen.

The message image 120 is displayed on the screen only at certain times, and while being displayed is always being moved. FIG. 1 shows the message being moved from top to bottom diagonally. The message may include a manufacturer's logo 121, as well as a discount coupon amount 122. The coupon can only be redeemed if the user actuates the message/logo while it is still visible on the screen. For example, the message/logo may be visible on the screen for a period of 60 seconds as it moves across the screen. Other amounts of time may also be possible. In another embodiment, the logo may move around the screen for a specified amount of time, for example 5 minutes.

At any point, the user can “capture” the moving coupon, by clicking on it during its appearance time. In the FIG. 4 embodiment, there may be a select button 420 which can be a mouse click button, or a select button on a media player, by the stylus being depressed of the logo on the screen, or the like. The item can also be selected via the remote control shown as 422. The selection allows downloading the coupon that can either be used on the internet, can be printed, or can display a discount code that they can use at a bricks and mortar type store. In this embodiment, selecting the area of the coupon, or simply pressing the “select” button during the time the ad is showing, brings up more information. This may be accomplished by sending an SMS message to a server that hosts the ad, or by bringing up a special website that hosts the coupon.

In an embodiment, the coupon may have an expiration date or time. FIG. 2 illustrates clicking on the moving ad 200, which provides a coupon 210. In the embodiment, the coupon has a coupon number, and expires in six hours. other numbers are of course possible.

In an embodiment, the ad is only a very small portion of the area of the display, for example 5% or less of the area of the display. Therefore, while the ad can be easily seen by a user looking at the display, it does not interfere with the user's ability to view the display even if they are not interested in the display.

An embodiment allows to be done with a mouse, on a television it can be done with a specified control. For example, the ad may say “press enter on your remote to select the ad”, or can be analogously selected on other platforms. For example, if the ad is displayed on a cellular phone, the user can press a specified key sequence to select the ad.

The coupons are presented to the store clerk, or simply the code is presented to the store clerk. An advantage of the short expiration coupon system is that the advertiser gets real time feedback on how well the advertising works. The store owner or website owner can count up the number of the ads that were redeemed. This shows the true value to the customer and/or consumer and/or merchant offering the discount.

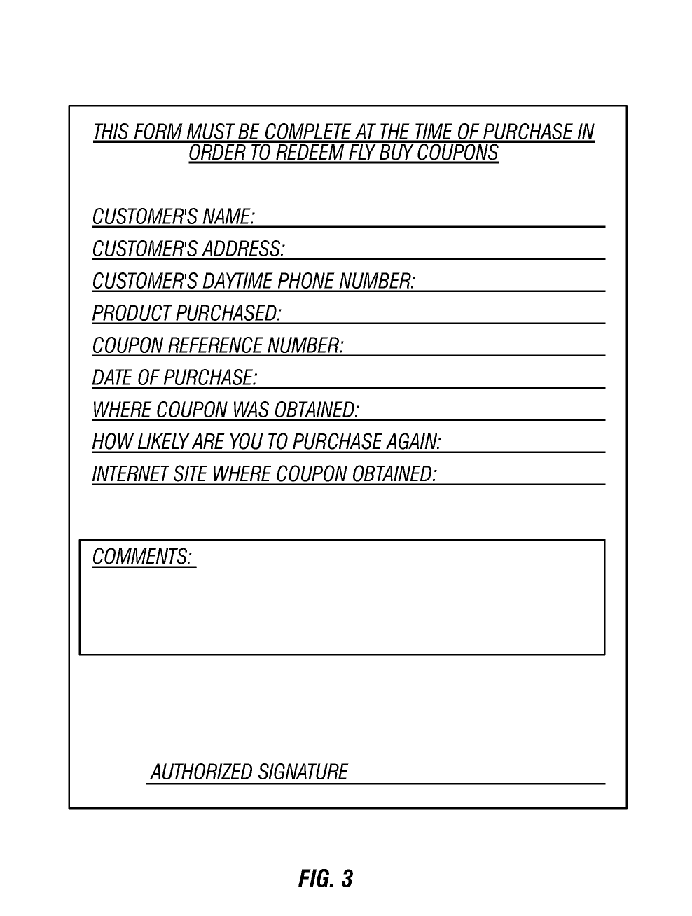

FIG. 3 illustrates an information sheet that the user may be required to fill out in order to use the coupon. For example, the user may have to fill out mailing list information in order to obtain the coupon. The form may be totally optional, however.

In the disclosed embodiment, the coupon itself is shown as an elliptical window, with an arrow showing the dollar amount of the discount. Of course, the coupon can have any desired shape. One advantage, however, of the specific shape shown in FIGS. 1 and 2 is that a first window can be used for the logo, and a totally separate window can be used for the discount amount. The two windows can have different shapes.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, the windows can have other shapes, can be used on other media players, and can be displayed or other periods of time.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned.

What is claimed is:

1. A method, comprising:
displaying media that is received over a channel on a screen of a media player device;
displaying an advertisement over said media, said advertisement displayed only on a portion of the screen of the media player device, and said displaying comprising continually moving the location of the advertisements so that the portion of the screen that is occupied by said advertisement continuously moves, said displaying occurring only for a limited amount of time; and
allowing actuating only during a time of said displaying to obtain a coupon code that is based on said advertisement, whereby said actuating after said displaying does not provide said coupon code.

2. A method as in claim 1, wherein said advertisement is displayed on 5% or less of an area of the screen of the media player device.

3. A method as in claim 1, wherein said coupon code includes expiration information.

4. A method as in claim 1, wherein said advertisement is formed of a first window part including a description of the product that is the subject of the discount, and a second window part including a description of the amount of the discount.

5. A method as in claim 4, wherein said first window part and said second window part have different outer shapes.

6. A method as in claim 1, further comprising, at a specified non zero time after said displaying, again displaying said advertising and allowing actuating said advertising during said again displaying.

7. A method as in claim 1, wherein said displaying media comprises displaying on a computer.

8. A method as in claim 1, wherein said displaying media comprises displaying on a cellular phone.

9. A media player device, comprising:
a display screen,
a connection to a channel which receives content that is displayed on said display screen; and
a window producing module, which produces a window that is displayed on said display screen, said window displaying an advertising forming only a portion of the screen of the content, and said window producing module continually moving a position of said window relative to the content, and displaying said window only for a specified time; and
a selection part, enabling selecting said advertising only during said specified time to produce discount information from said advertising while moving.

10. A media player as in claim 9, wherein said window occupies an area of 5% or less of an overall area of the display screen.

11. A device as in claim 9, wherein said window producing module produces a coupon with an expiration information thereon.

12. A device as in claim 9, wherein said window producing module produces a first window part of that describes a product and a second window part that describes a discount that is available on said product.

13. A device as in claim 9, wherein said first window part in said second window part define different outer shapes.

14. A device as in claim 9, further comprising again displaying said window some time later.

15. A device as in claim 9, wherein said media player includes a computer.

16. A device as in claim 9, wherein said media player includes a cellular telephone.

17. A device as in claim 9, wherein said media player includes a television.

18. A method, comprising:
receiving media over a channel;
displaying said media on a display device;
at a first specified time, displaying an advertisement over said media, over only a portion of the screen of them media player, while continually moving a location of the advertisement on the screen of the media player;
after a second specified time, terminating said displaying said advertisement over the media;
at a third specified time, after said first specified time, again displaying an advertisement over only a portion of the media player while continually moving the location of the advertisement on the screen, and terminating the displaying after a fourth specified time; and
while said advertisement is being displayed, allowing actuating an area of the screen defining the advertisement to obtain a coupon code based on the advertisement.

19. A method as in claim 18, wherein said advertisement occupies 5% or less of the area of the screen.

20. A method as in claim 18, wherein said advertisement is formed of a first window showing the display device and a second window showing a discount amount.

21. A method as in claim 20, wherein said first and second windows have different outer shapes.
